(19) United States
(12) Patent Application Publication
(10) Pub. No.: US 2006/0237230 A1
(43) Pub. Date: Oct. 26, 2006

(54) DISASSEMBLY DEVICE FOR DISASSEMBLING A PRODUCT

(76) Inventor: Li-Chin Lu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,474

(22) Filed: Mar. 29, 2006

(30) Foreign Application Priority Data
Apr. 22, 2005 (CN) 200520057615.4

(51) Int. Cl. H02G 3/08

(52) U.S. Cl. 174/481

(57) ABSTRACT

A disassembly device for disassembling a product into two separate parts is disclosed. The product has a plurality of openings at a bottom thereof. The disassembly device includes a driver member, a supporting member, and a securing piece. The supporting member is connected with the drive member and includes a plurality of hooks. The hooks are driven to move up and down when driven by the drive member, and whereby the hooks insert into the openings, engaged with the product, and disassemble the assembled product. The securing piece is for controlling horizontal movement of the supporting member, and thereby securing a housing of the assembled product in position.

### TECHNICAL FIELD

The present invention relates generally to disassembly devices, and more particularly to a disassembly device for disassembling a product such as an electronic device enclosure.

### DESCRIPTION OF RELATED ART

As the electronics industry continues to advance, people's lives are being rapidly changed. All kinds of electronic products, such as computers and mobile telephones, are commonly used in many people's lives. Today, electronics producers expend much manpower and material resources in order to improve the performance of their products.

A traditional desktop or tower personal computer is housed in an enclosure. The enclosure usually contains a plurality of components such as a motherboard, interface cards, floppy disk drives, hard disk drives, and optical disk drives. For most personal computers, if a person needs to test, perform maintenance on, or replace any of the components, the enclosure needs to be disassembled.

Traditional means for disassembling the enclosure are rather inefficient. The procedures often involve a large number of manual tasks, which are not only time consuming, but also can lead to accidental bumping or touching of components. If accidental bumping or touching occurs, these may damage the enclosure or components contained therein. In particular, if enclosures are disassembled in a mass manufacturing facility, the yield rate of defect-free products is liable to be reduced.

What is needed is a disassembly device which can readily and safely disassemble a product such as an electronic device enclosure.

### SUMMARY

A disassembly device for disassembling a product in accordance with a preferred embodiment of the present invention comprises a drive member and a workbench. The disassembly device is used for a product into two separate parts, the product has a plurality of openings at a bottom thereof. The workbench includes a supporting member and a securing piece. The supporting member is connected with the drive member and includes a plurality of hooks. The hooks are driven to move up and down when driven by the drive member, whereby the hooks insert into the openings, engaged with the product, and disassemble the assembled product. The securing piece is for controlling horizontal movement of the supporting member, and thereby securing a housing of the assembled product in position.

Other advantages and novel features will be drawn from the following detailed description of preferred embodiments with reference to the attached drawings, in which:

### BRIEF DESCRIPTION OF DRAWINGS

FIG. 1 is an exploded, isometric view of an exemplary enclosure including a housing and a chassis in accordance with a preferred embodiment of the present invention;

FIG. 2 is an isometric view of a disassembly device for use on the enclosure of FIG. 1, in accordance with a preferred embodiment of the present invention; and

FIG. 3 is a top view of the disassembly device of FIG. 2.

### DETAILED DESCRIPTION OF THE PREFERRED EMBODIMENTS

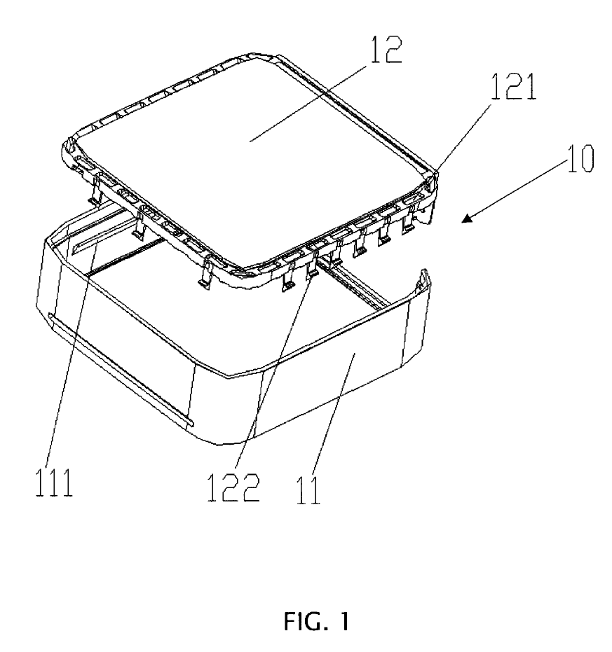

A disassembly device according to preferred embodiments of the present invention will be described with reference to FIGS. 1 to 3. Referring to FIG. 1, this is an exploded, isometric view of an assembled product 10 such as a computer enclosure. The enclosure 10 includes a housing 11 and a chassis 12. The housing 11 defines a plurality of gains 111 in a plurality of inner walls thereof. Correspondingly, the chassis 12 is equipped with a plurality of grabs 122. The housing 11 is attached to the chassis 12 by way of the gains 111 engagingly receiving the grabs 122, thereby providing the assembled enclosure 10. However, electronic components inside the enclosure 10 may require maintenance or replacement. Therefore, the disassembly device 20 is provided to perform a disassembly operation on the enclosure 10.

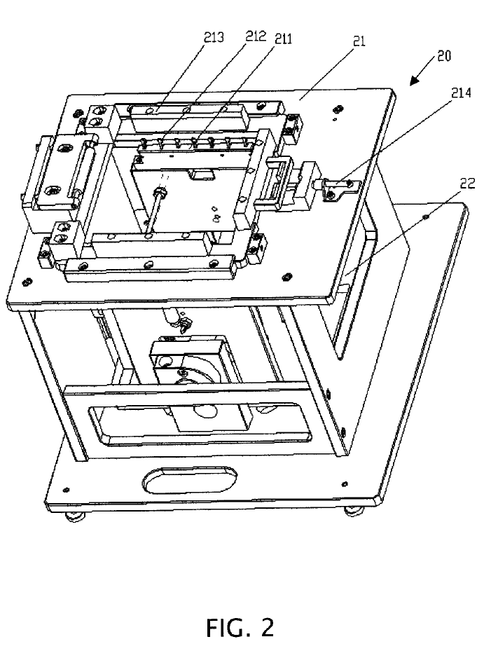

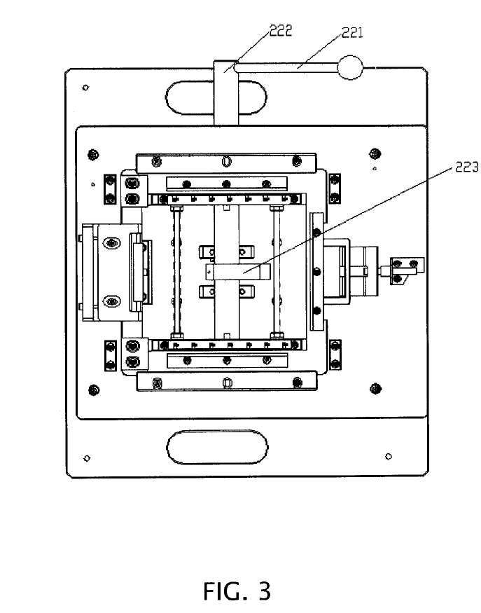

Referring to FIGS. 2 and 3, the disassembly device 20 includes a drive member 22 and a workbench 21. The drive member 22 includes a rocker shaft 221, a cam shaft 222, and a cam 223. Consequently, the drive member 22 can be driven in a cam drive manner. In particular, when the rocker shaft 221 attached to the cam shaft 222 is turned by an operator, the cam 223 is driven correspondingly. In other embodiments, other appropriate driving means may be used. The workbench 21 includes a supporting member 211, a plurality of baffles 213, and a securing piece 214 thereon. The baffles 213 are for facilitating fixing of the enclosure 10 in position when the enclosure 10 is placed on the workbench 21. The securing piece 214 is for controlling the supporting member 211 to move horizontally, and thereby securing the housing 11 in position on the workbench 21. In the preferred embodiment, the securing piece 214 is a high-speed clamp. The supporting member 211 supports the enclosure 10 placed thereon, and is connected with the cam 223. When the cam 223 turns, the supporting member 211 is driven to move up and then down in a continuous motion. The supporting member 211 includes a plurality of hooks 212 thereon, which cooperate with openings 121 defined in the chassis 12. When the supporting member 211 is driven to move up and down, the hooks 212 move up and down along with the supporting member 211. When the supporting member 211 moves up, the hooks 212 insert into the openings 121. When the supporting member 211 moves back down, the hooks 212 hitch onto sides of the chassis 12 bounding the openings 121 and pull the chassis 12 down and out from the enclosure 10, thereby disassembling the enclosure 10.

Detailedly, the process of disassembling the enclosure 10 is as follows: the enclosure 10 is placed on the supporting member 211 of the disassembly device 20. The supporting member 211 with the hooks 212 is driven to move up, and the openings 121 of the chassis 12 receive the hooks 212. The securing piece 214 is then controlled to push the supporting member 211 to move horizontally. Thereby, the housing 11 of the enclosure 10 is secured in position on the workbench 21. In this process, the hooks 212 can move horizontally inside the openings 121 of the enclosure 10, because the openings 121 are somewhat elongate. The securing piece 214 thus quickly secures the housing 11 of the enclosure 10 in a fixed position. The supporting member 211 with the hooks 212 is then driven to move down by the cam 223, and the hooks 212 hitch onto the sides of the chassis 12 bounding the openings 121. Thus hooks 212 pull the chassis 12 down and away from the housing 11, with the grabs 122 of the chassis 12 disengaging from the gains 111 of the housing 11. Thereby, the enclosure 10 is disassembled.

Although the present invention has been specifically described on the basis of preferred embodiments, the invention is not to be construed as being limited thereto. Various changes or modifications may be made to the embodiments without departing from the scope and spirit of the invention.

What is claimed is:

1. A disassembly device for disassembling a product into two separate parts, the product having a plurality of openings at a bottom thereof, the disassembly device comprising:
a drive member; and
a supporting member which is connected with the drive member and which comprises a plurality of hooks, wherein the hooks are driven to move up and down when driven by the drive member, whereby the hooks insert into the openings, engage with the product, and disassemble the assembled product.

2. The disassembly device as claimed in claim 1, further comprising a securing piece for controlling horizontal movement of the supporting member, and thereby securing a housing of the assembled product in position.

3. The disassembly device as claimed in claim 2, wherein the securing piece is a high-speed clamp.

4. The disassembly device as claimed in claim 1, wherein the drive member comprises a rocker shaft, a cam, and a cam shaft, wherein the cam shaft is driven to turn when the rocker shaft is turned, thereby driving the cam to turn.

5. The disassembly device as claimed in claim 4, wherein the hooks move up and down when the cam turns.
